(19) United States
(12) Patent Application Publication
(10) Pub. No.: US 2015/0371287 A1
(43) Pub. Date: Dec. 24, 2015

(54) SYSTEM AND METHOD FOR ANALYSING AND PROFILING CLIENT INTERACTION

(71) Applicant: Suna IP Pty Ltd., Bulimba (AU)

(72) Inventors: Russell TAYLOR, Bulimba (AU); Scott DUNLOP, Bulimba (AU); Jesse CLAVEN, Bulimba (AU)

(21) Appl. No.: 14/747,414

(22) Filed: Jun. 23, 2015

(30) Foreign Application Priority Data
Jun. 24, 2014 (AU) 2014203427

(51) Int. Cl. G06Q 30/02; H04L 29/08; G06Q 50/16; G06F 17/30

(52) U.S. Cl. CPC G06Q 30/0276; G06F 17/30536; H04L 67/306; G06Q 30/0254; G06Q 30/0269; G06Q 50/16

(57) ABSTRACT

The current invention is directed to a system for analysing client interaction history. The system comprises a server configured to receive and process a master document, and generate therefrom a plurality of unique newsletters. The server is further configured to send each unique newsletter to a corresponding client. The system also has a database storing therein records of all interaction activity with a unique newsletter by a corresponding client, wherein the server is further configured to retrieve selected records from the database and calculate therefrom one or more statistics and recommendations for the agent.

### FIELD OF INVENTION

The present invention relates to a system and method for analysing and profiling client interaction within a digital marketing environment, and generating automatic recommendations from the analysis. The present invention has particular but not exclusive application in online real estate marketing systems.

### BACKGROUND OF THE INVENTION

Marketing, in particular real estate marketing, has predominantly been a passive and reactive endeavour involving advertising to as large an audience as possible, with an aim of receiving enquires from interested parties. The options available to sales and marketing agents to actively identify and target interested parties are limited. Moreover, from a buyer's perspective, the searching of classifieds, listings, and the like is a tedious and time consuming process.

There is a need for a system and method to generate sales and marketing intelligence allowing agents to proactively identify and target relevant audiences, and to likewise allow buyers to receive well targeted communications relevant to their needs.

### OBJECT OF THE INVENTION

It is one object of the present invention to provide a system and method that analyses and profiles the activity of clients in a marketing system, so as to allow agents to actively identify and contact clients, and to allow clients to be more passively advised of ideal properties.

It is another object of the present invention to provide a system and method that analyses and reports on the activity of clients in a marketing system, so as to allow agents to quantifiably appraise their marketing activities in the marketing system.

These and other objects of the present invention will become apparent from the following disclosure of the invention.

### SUMMARY OF THE INVENTION

According to a first aspect of the present invention, a system for analysing client interaction history is provided. The system includes a first electronic device operated by an agent, the first electronic device generating a master document containing informational material and one or more URL links to properties listed on an online web portal; a server connected to the first electronic device via a network, the server configured to process the master document and generate therefrom a plurality of unique newsletters, the server further configured to send each unique newsletter to a corresponding client; and a database storing therein records of all interactions of each client with a corresponding newsletter, wherein the server is further configured to retrieve selected records from the database and calculate therefrom one or more statistics and recommendations for the agent.

Preferably, each newsletter generated by the server contains therein URL links unique to each newsletter, whereby an interaction of a client with a unique URL link identifies the client and the client's interaction with the URL link to the database for recordation.

Preferably, the server is configured to generate a variety of profiles for the agent, each profile comprising a different combination of statistics and recommendations.

In one form, the server is configured to generate a client profile identifying one or more of a number of times a client opened a newsletter, a number of times a client licked on a URL link in a newsletter, a hypothetical ideal property for the client, an estimated price range of the client, likely property locations desired by the client, and likely property types desired by the client.

Preferably, the server is configured to retrieve from the database records of all previous properties viewed by the client, and calculate therefrom one or more of an average number of bedrooms of all properties, an average number of bathrooms of all properties, and an average number of parking spaces of all properties, wherein the hypothetical ideal property is generated by the server as a property having the calculated average number of bedrooms, bathrooms, and parking spaces.

Preferably, the server is configured to retrieve from the database records of all previous properties viewed by the client, and calculate therefrom an average price of all properties, wherein an estimated price range of the client is determined as the calculated price.

Preferably, the server is configured to generate a graph illustrating the price ranges of all previously viewed properties as a percentage of all properties.

Preferably, the server is configured to retrieve from the database records of all previous properties viewed by the client, determine therefrom the location of each property, and determine the most likely property locations desired by the client.

Preferably, the server is configured to retrieve from the database records of all previous properties viewed by the client, determine therefrom the type of each property, and determine the most likely property type desired by the client.

In another form, the server is configured to generate a property profile identifying one or more of a client picture describing characteristics of a hypothetical client likely to be interested in a specific property, and a list of matching clients matching the hypothetical client.

Preferably, the server is configured to retrieve from the database records of all client interactions indicative of a viewing of the specific property, determine therefrom characteristics of each client who viewed the specific property, and calculate therefrom one or more of an average client age, a statistical client gender, an average client salary, a statistical client marital status, and a list of common property locations, whereby the hypothetical client is generated as a person of the average age, of the statistically higher gender, earning the average client salary, of the statistically higher marital status, and who is looking for properties in locations listed in the list of common property locations.

Preferably, the server is configured to retrieve from the database a list of clients whose characteristics are within a predetermined matching threshold of those of the hypothetical client.

In another form, the server is configured to generate an agent profile identifying one or more clients of the agent determined by the server to be a match for one or more properties managed by the agent.

Preferably the server is configured to retrieve from the database a list of clients whose recorded activity exceed a predetermined threshold, to determine therefrom a possible intent of the client, and to generate a suggested action for the agent to take in relation to the client.

Preferably, the server is configured to determine from the database client activity indicative of a predetermined number of URL links clicked by a client, analyse characteristics of properties represented by the clicked URL links, and determine that the client is investigating a market within an area if the properties are within a close geographic vicinity.

Preferably, the server is configured to recommend to the agent to send the client informational area about the area in response to determining that the client is investigating the marketing within the area.

Preferably, the server is configured to retrieve from the database one or more properties managed by the agent, retrieve from the database the interaction activity of all clients managed by the agent, and determined from the interaction activity if any clients are a match for the one or more properties.

In another form, the server is configured to retrieve from the database client activity on all newsletters sent in a predetermined period, and determine from the client activity one or more of an optimal sending time for the newsletters, and an optimal subject description for the newsletters.

Preferably, the server is configured to retrieve from the database all occurrences of clients opening any of the newsletters sent in the predetermined period, the times of such occurrences, and determine therefrom the times during which a highest open rate occurred, whereby the optimal sending time for the newsletters is determined.

Preferably, the agency profile includes a graph illustrating the open rate of newsletters against the times at which the newsletters were opened, whereby a graphical illustration of the optimal sending times for the newsletters is presented.

Preferably, the server is configured to retrieve from the database all occurrences of clients opening any of the newsletters sent in the predetermined period, the words present in a subject line of each of the newsletters, and the number of times each newsletter was opened, and determined therefrom the words present in the subject lines of the most opened newsletters, whereby the optimal subject description for the newsletters is determined.

In one form, one or more of the variety of profiles is generated in response to the agent clicking on an initiating URL link sent thereto.

In another form, one or more of the variety of profiles is generated upon the agent newly listing a property.

### BRIEF DESCRIPTION OF THE DRAWINGS

In order that the present invention can be more readily understood, reference will now be made to the accompanying drawings which illustrate preferred embodiments of the invention and wherein:

FIG. 1 illustrates a client-activity analysing and profiling system;

FIG. 2 is a flow chart of an exemplary client-activity collection and recordation operation;

FIG. 3 is a flow chart of a profile generating operation;

FIG. 4 illustrates a client profile;

FIG. 5 is a flow chart of a client profile generation operation;

FIG. 6 illustrates a property profile;

FIG. 7 is a flow chart of a property profile generation operation;

FIG. 8 illustrates a newsletter profile;

FIG. 9 is a flow chart of a newsletter profile generation operation;

FIG. 10 illustrates an agent profile;

FIG. 11 is a flow chart of an agent profile generation operation;

FIG. 12 illustrates an agency profile;

FIG. 13 is a flow chart of an agency profile generation operation; and

FIG. 14 illustrates various triggers/initiators of the profile generating operation.

### DETAILED DESCRIPTION OF PREFERRED EMBODIMENTS

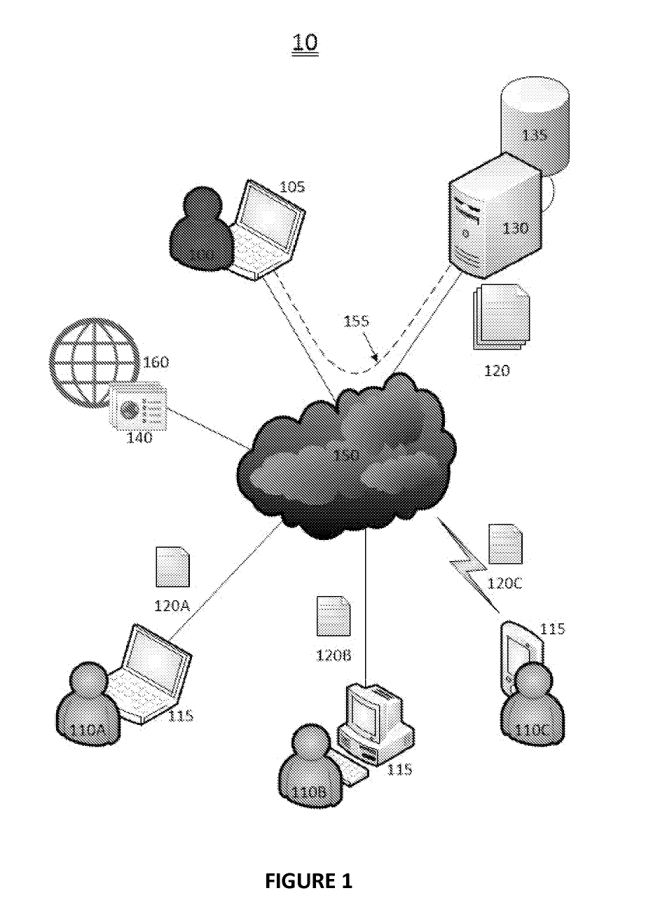

A client-activity analysing and profiling system 10 according to the present invention is illustrated in FIG. 1. The system 10 is configured to record and store the interaction of one or more clients 110A, 110B, 110C with marketing materials 120A, 120B, 120C sent thereto by an agent 100. The system 10 is further configured to subsequently analyse the recorded interactions to generate therefrom a variety of profiles.

In a preferred form, the marketing materials 120A-C include periodic newsletters discussing one or more relevant topics. In other forms, the marketing materials 120A-C may include social media posts/tweets, RSS feeds, hard copy publications/materials, and the like. The marketing materials 120A-C list therein URL links to one or more goods and/or services for sale. For the purposes of this description, the marketing materials 120A-C are exemplarily taken to be email newsletters 120A-C containing links to one or more webpages/listings 140 of a real estate listing portal 160.

The newsletters 120A-C in the preferred form are derived from a master document 120. The master document 120 is prepared by the agent 100 and processed by an email marketing server 130 to create the newsletters 120A-C. The newsletters 120A-C are created by the marketing server 130 from the master document 120 to include identifiers uniquely identifying one newsletter 120A-C from another. Such identifiers include, for example, unique URL links, unique URL extensions, unique remote image links, and the like. In being unique, each newsletter 120A-C and an interaction therewith by a corresponding client 110A-C can be distinguished.

The system 10 is configured to record a client's interactions with a newsletter 120A-C. The client's interactions are recorded in an activity database 135 of the marketing server 130. The recorded interactions include, for example, opening of the newsletters 120A-C, navigating to a link listed in the newsletter 120A-C, viewing a webpage 140 associated with the link, interacting with the webpage 140, and the like. Also stored in the activity database 135 are the personal details of each client 120A-C.

The recordation of client interactions with the newsletters 120A-C creates over time a store of activity data in the activity database 135. As will be described in greater detail below, this activity data is analysed to provide the agent 100 with historical and statistical profiles on each client 110A-C as well as the newsletters 120A-C and the properties listed in the webpages/listings 140.

The ability to profile clients 110A-C allows the agent 100 to provide targeted communication to each client 110A-C. Examples of targeted communications include targeted newsletter listing properties of interest to a client, direct contact with a client when new properties of interest are listed, and the like. Accordingly, the agent 100 is provided with a proactive means of identifying and contacting clients.

The system 10 includes the profile server 130 and the database 135 connected thereto. The database 135 in one form is connected to the profile server 130 directly or via an internal network, but in other forms may be remote from the profile server 130 and connected thereto via an external network 150, such as the Internet.

The system 10 further includes an electronic device 105 connecting the agent 100 to the network 150. The electronic device 105 is, for example, a laptop, desktop, smartphone, or tablet. The agent 100, via the network 150, has authorized access to the profile server 130, as illustrated by the link 155.

Each client 110A-C is connected to the system 10 via the network 150. Each client 110A-C connects to the network 150 via a variety of electronic devices 115, such as laptops, desktops, smartphones, tablets, and the like. Each client 110A-C is subscribed with the system 10 to receive the newsletters 120A-C from the agent 100 and profile server 130. Each client 110A-C is further able to access various web portals 160 and webpages/listings 140. The web portals 160 and webpages 140, in one form, host listings of properties for sale, some of which are managed by the agent 100.

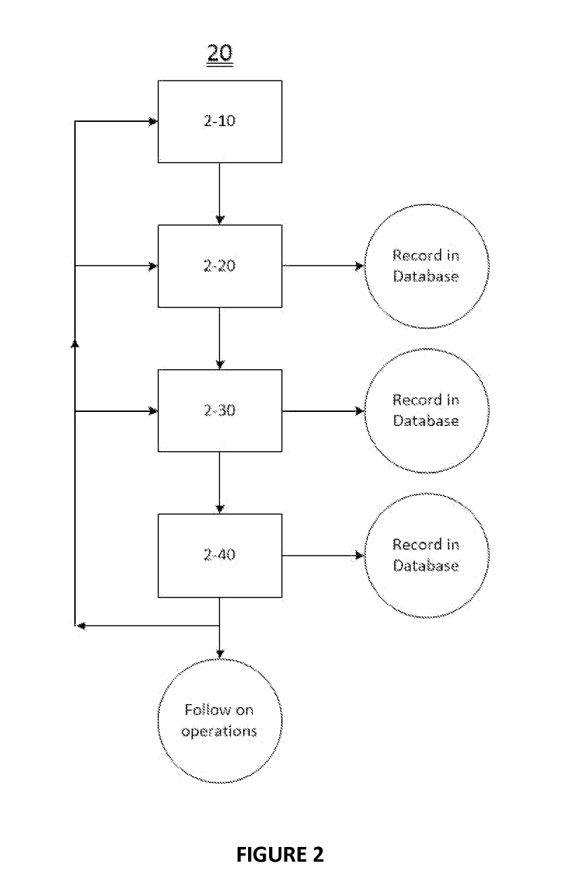

In the system 10 of the present invention, the database 135 stores records of client interactions with the marketing materials 120A-C. The records of client interactions may be collected in a variety of ways. With reference to FIG. 2, an exemplary client-activity collection operation 20 for collecting and recording client interactions is described.

The exemplary collection operation 20 commences at 2-10 with the agent 100 sending to the clients 110A-C a communication such as the newsletters 120A-C. As described above, the newsletters 120A-C are derived from a master document 120 processed and/or created by the profile server 130. The newsletters 120A-C are uniquely identified, one for each client 110A-C. The profile server 130 maintains a record of which newsletters 120A-C have been sent to which client 110A-C.

At 2-20, the clients 110A-C receive respective newsletters 120A-C. One or more clients 110A-C may open and read the newsletter 120A-C. The act of opening and reading the newsletter 120A-C is recorded in the database 135. The clients' act of opening the newsletters 120A-C may be detected in a variety of manners. In a preferred form, detection is effected by way of unique tracking images in the content of the newsletters 120A-C. Each time a unique tracking image is downloaded as part of the marketing email 120A-C, the download thereof is recorded to the database 135 as an act of the clients 110A-C having opened a newsletter 120A-C.

At 2-30, one or more clients 110A-C further interact with the newsletter 120A-C, for example by clicking on a URL in the newsletter 120A-C. As each link in each newsletter 120A-C is unique, the clients' act of clicking on and viewing the URL is trackable, and recorded in the database 135.

At 2-40, one or more clients interact with a web page 140 (or other URL target) identified by the URL. Exemplary interactions with the webpage 140 include, for example, navigating to subsidiary URL's listed on the webpage 140, viewing photos listed on the webpage 140, sharing the webpage 140 with a friend, adding a property listed on the webpage 140 to the client's list of favourites, and the like. All such activity is recorded in the database 135.

The collection operation 20, over time, builds up a record of clients' activities in the database 135. It should be understood that the present invention is not limited to the above-described client-activity collection operation 20. Other methods and operations for collecting and recording client interaction may be implemented. In one form, collection and recordation of client activity is realized by the method and system disclosed in the applicant's International Application no. PCT/AU2011/000107 (now published as WO2011094809 A1), the contents of which are herein incorporated by reference.

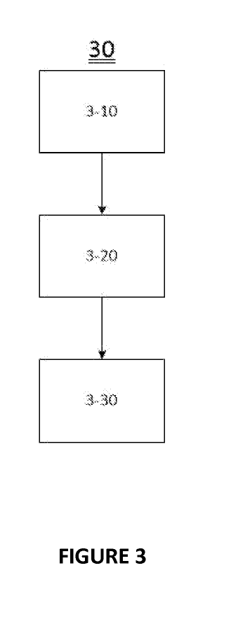

With reference now to FIG. 3, an operation 30 for analysing the client activity records in the database 135, and generating various profiles therefrom, is described. The operation 30 commences at 3-10 where the server 130 receives an instruction to generate a profile. Included with the instruction to generate a profile is an indication of the type of profile to generate. The types of profile that may be generated include:
Client Profile—A client profile provides historical and statistical information in regards to a client's past interactions with the marketing material 120A-C. Exemplary types of information include the type of properties the client has viewed, the number of times a client has viewed a particular property listing, the suburbs/cities in which the properties are located, the sizes of the properties, the facilities/characteristics (e.g. pool, parking spaces, etc.) of properties, and so forth.
Property Profile—A property profile provides historical and statistical information of a property listing. Exemplary types of information include the age of clients that have viewed the property, the salary range of such clients, the marital and family statuses of such clients, other properties that the clients have also viewed, and so forth. The property profile may also include a list of recommended clients 110A-C who may be interested in the property based on their client profile.
Newsletter Profile—A newsletter profile provides historical and statistical information about a newsletter. Exemplary types of information include the number of times the newsletter was opened/read, which clients 110A-C have opened/read a newsletter, the number of times each link in the newsletter was navigated to, a profile of clients who clicked on each link, and so forth.
Agent Profile—An agent profile provides historical and statistical information of all activity related to an agent. Exemplary types of information include the marketing material 120A-C that an agent has sent out, statistics on each piece of marketing material 120A-C (such as how many clients 110A-C have viewed the material, how many links have been clicked on, and the like), newest subscribers to an agent's marketing mail out, recent activity of clients 110A-C who have receive the agent's marketing material 120A-C, and the like.
Agency Profile—An agency profile provides historical and statistical information of all activity related to an entire agency, of which a plurality of agents may be a part. Exemplary types of information include the marketing material 120A-C that all agents have sent out, statistics on each piece of marketing material 120A-C (such as how many clients 110A-C were subscribed to a piece of material, how many clients 110A-C viewed the material, average open rates for each piece of material, and the like), and statistics for each agent (such as how many clients 110A-C each agent manages, the average open rate of materials for each client of an agent, properties sold by each agent, and the like)

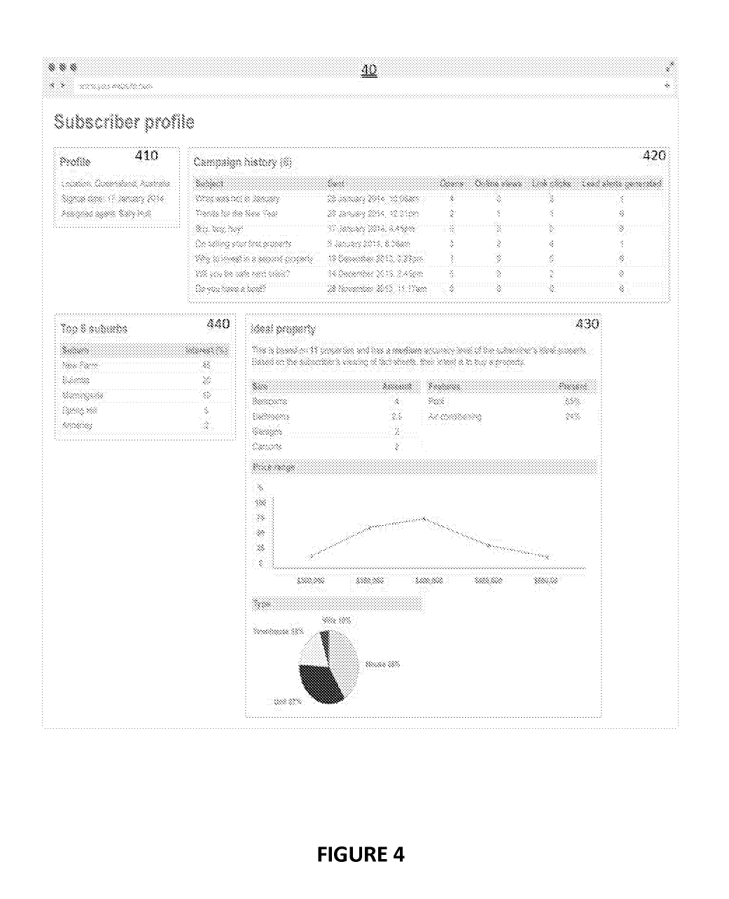

At 3-20, the database 135 is accessed by the server 130 to retrieve relevant data from the database 135 for generating the indicated type of profile. The retrieved data is analysed and manipulated to generate the required information for the various profiles. Included in the manipulation of the retrieved data is the calculation of graphs, charts, recommendations, and statistics. The type of data retrieved, and the data manipulations conducted, for the generation of each profile are described in greater detail below with reference to FIGS. 4 to 13.

At 3-30, the server 130 processes the retrieved data into a requested format(s), thereby creating the profile. Suitable formats for the profile include email, text message, private messaging, webpage, spreadsheets, and the like. Once created, the profile in the requested format is sent to the agent 100.

FIG. 4 illustrates an exemplary client profile 40. The client profile 40 includes basic information 410 of the client, such as the client's location, signup date, and assigned agent. The basic information 410 is obtained from the server 135. In one form, the basic information 410 is entered by the client 110A-C during a signup process to subscribe to the system 10. The basic information 410 may also include the client's age, gender, annual salary, contact details, and the like.

The client profile 40 further includes a newsletter interaction history 420. The newsletter interaction history 420 lists the number of times a newsletter 120A-C was opened by the client 110A-C, how many URL's within the newsletter 120A-C the client clicked on, and the like.

The client profile 40 further includes a property picture 430. The property picture 40 is generated based on the client's past interactions and describes a hypothetical ideal property that the client 110A-C appears to be interested in. The property picture 430, in one form, is generated by averaging characteristics of properties that the client 110A-C has viewed historically. The property picture 430 includes, for example, a number of bedrooms, bathrooms, garages, carports, and other characteristics of the hypothetical property. Property features such as pools, air-conditioning, tennis courts, and the like, in one form, are represented as a percentage calculated from previous properties viewed by the client 110A-C.

The client profile 40 further includes a price range graph 435 calculated from the prices of previously viewed properties, thereby providing an indication of the approximate budget of the client 110A-C.

The client profile 40 further includes a location picture 440. The location picture 440 is generated from historical data of previously viewed properties. The location picture 440, in one form, is generated as a percentage view of the various locations (e.g. suburbs/cities) that previously viewed properties were located in.

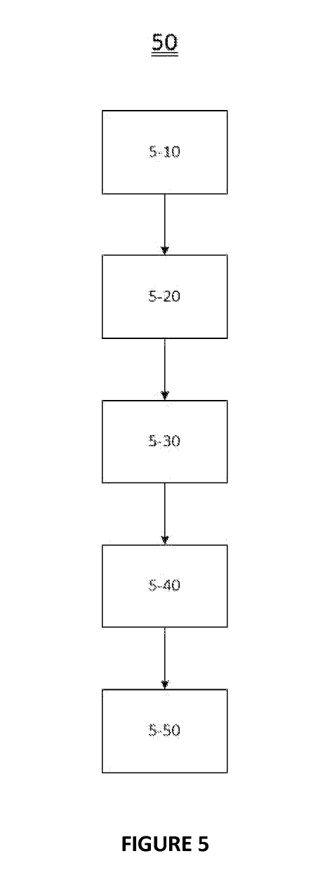

An operation 50 for generating the client profile 40 is described with reference to the flow chart of FIG. 5.

The operation 50 commences, exemplarily, at 5-10 where basic information about a client in question is retrieved from the database 135. The basic information retrieved includes, for example, a location of the client, a signup date of the client, and the agent assigned to the client. The basic information is stored in the database as part of a user profile populated by the client when subscribing to the system 10.

At 5-20, the newsletter interaction history 420 for the client in question is generated. The newsletter interaction history 420 is generated by retrieving from the database 135 statistics recorded for the client in relation to their interaction with the newsletters 120A-C.

At 5-30, the property picture 430 is generated. The property picture 430 is generated by retrieving from the database 135 a list of all properties that the client has previous viewed. From the list of properties, the server 130 calculates an average for the number of bedrooms, bathrooms, garages, and parking spaces. Additionally, from the list of properties, a percentage is calculated of properties featuring features such as pools, air-conditioning, tennis courts, and the like. From the calculated averages and percentages, the hypothetical ideal property is generated. In the example illustrated in FIG. 4, for example, the hypothetical ideal property has 4 bedrooms, 2.5 bathrooms, 2 garages, 2 carports, and is 65% likely to have a pool, but only 24% likely to feature air-conditioning.

At 5-40, the price range graph 435 is generated. The price range graph 435 is generated by retrieving from the database 135 all properties that the client has previously viewed and utilizing the server 130 to analyse, calculate, and graph the prices of each property statistically. In one form, the server 130 analyses the prices of each property previously viewed by the client and calculates therefrom a histogram as the price range graph 435.

At 5-50, the location picture 440 is generated. To generate the location picture 440, a list of all properties previously viewed by the client is retrieved from the database. The server 130 groups each property in the list by location (e.g. suburb), and list the groups in order of size. In one form, the top 5 or top 10 largest groups are displayed as the location picture 440. A relative size of each group represented as a percentage is also calculated by the server 130.

It is to be understood that the operation 50 may be performed in a different order, and that the steps 5-10 to 5-50 need not be consecutive.

The client profile 40, having the newsletter interaction history 420, property picture 430, price range graph 435, and location picture 440 forms a profile that informs the agent 100 of the likely type of property that the client 110A-C is seeking. From the client profile 40, the agent 100 is able to better target available properties for the client

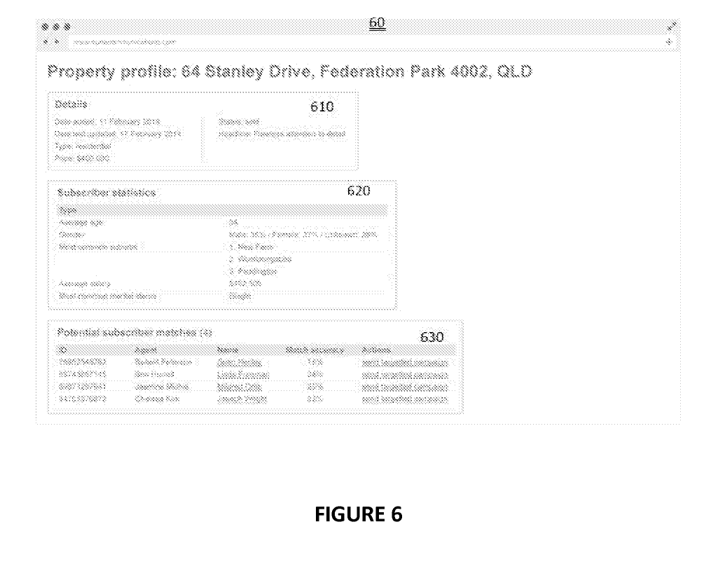

FIG. 6 illustrates an exemplary property profile 60. The property profile 60 includes basic property information 610, a client picture 620, and a list of potential client matches 630.

The basic property information 610 lists basic information about the property such as the type of property, the price of the property, the date the property was listed, and the like.

The client picture 620 provides statistics regarding the clients who had previously viewed a listing for the property, thereby building a rough picture of the type of client interested in the property. Included within the client picture 620 is, for example, an average age of the clients who viewed the property, an analysis of the gender of the clients who viewed the property, the most common locations for properties that the clients were searching in, an average salary of the clients, a most common marital status of the clients, and the like.

From the client picture 620, the list of potential client matches 630 is generated. The list of potential client matches 630 lists one or more clients 110A-C who fit the client picture 620. In the example of FIG. 6, for example, the list of potential client matches 630 might list every client 110A-C who is aged in the vicinity of 34, has a salary approximately in the vicinity of $102,500, is not married, and is generally looking for properties in or around the suburbs of ‘New Farm’, ‘Woolloongabba’, and ‘Paddington’. Other statistics may also be used, such as whether the client has children, number of vehicles owned, work location, and the like.

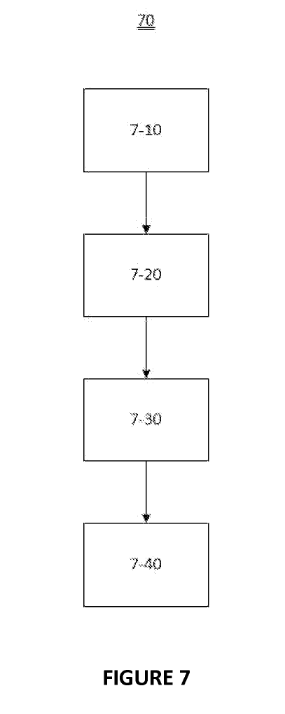

An operation 70 for generating the property profile 70 is described with reference to the flow chart of FIG. 7.

The operation 70 commences, exemplarily, at 7-10 where the basic property information 610 is generated. The basic property information 610 is retrieved from the web portal 160. The basic property information 610, in one form, is retrieved from the web portal 160 by the server 130 using a property identifier identifying the listing 140 in the web portal 160.

At 7-20, the server 130 searches the database 135 to retrieve therefrom basic client information of each client whose recorded client activity indicates that the client viewed the property in question. Additionally, or alternatively, for each client whose recorded client activity indicates that the client viewed the property, a client profile generation operation 50 (FIG. 5) or part thereof is conducted.

At 7-30, from the information retrieved and/or generated at 7-20, the server 130 calculates and generates the client picture 620 which describes a hypothetical client. In one form, the server 130 calculates an average age and salary from the ages and salaries of all clients retrieved in 7-20. Similarly, a percentage is calculated for the clients' gender. If a client profile generation operation was conducted in 7-20, additional information such as common suburbs viewed by all clients retrieved in 7-20 is also determined by the server 130.

At 7-40, the server 130 queries the database 135 for clients 110A-C whose profiles (e.g. age, gender, salary range, etc.) are within a certain vicinity of the hypothetical client described by the client picture 620. From the results of the query, the list of potential client matches 630 is generated. The list of potential client matches includes a match accuracy, calculated by the server 130 as a percentage of how many of a matched client's characteristics are within a predetermined vicinity of the hypothetical client.

It is to be understood that the operation 70 may be performed in a different order, and that the steps 7-10 to 7-40 need not be consecutive.

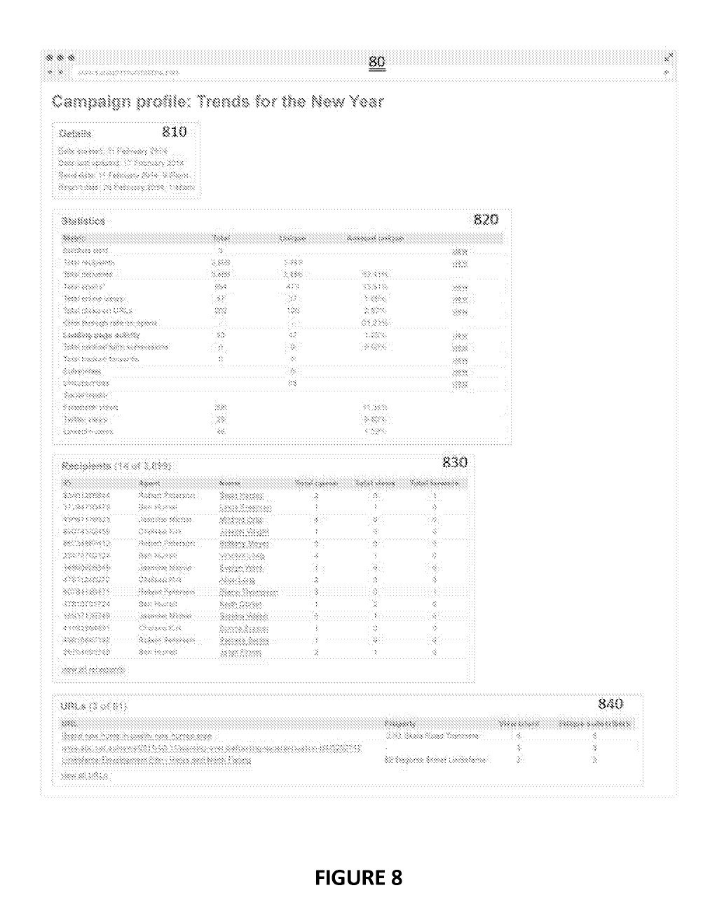

FIG. 8 illustrates an exemplary newsletter profile 80. The newsletter profile 80 includes basic newsletter information 810, newsletter statistics 820, newsletter recipients 830, and newsletter URLs 840.

The basic newsletter information 810 lists basic information about the newsletter 120A-C, including the date the newsletter 120A-C was created, the date the newsletter 120A-C was last updated, the date the newsletter 120A0C was sent, and the date at which the newsletter profile 80 was generated.

The newsletter statistics 820 provides statistics generated so far in relation to the newsletter 120A-C. Included in the newsletter statistics 820 are the total recipients addressed, the total recipients successfully delivered to, a total number of times the newsletter was open, a total number of unique times the newsletter was opened, total number of clicks of URLs listed in the newsletter, and the like.

The newsletter recipient list 830 lists all recipients who received the newsletter 120A-C. Included with this information is the total number of times each recipient opened the newsletter, total number of times the recipient viewed the newsletter, and the total number of times the recipient forwarded the newsletter.

The newsletter URLs list 840 lists each URL that was mentioned in the newsletter 120A-C. Included in the newsletter URLs list 840 are the property associated with the URL, a total number of views of the property associated with the URL, and a total number of unique subscribers who viewed the URL.

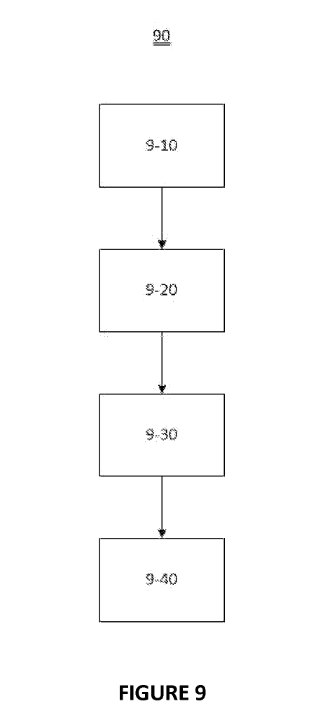

An operation 90 for generating the newsletter profile 80 is described with reference to the flow chart of FIG. 9. The operation 90 commences, exemplarily, at 9-10 where the basic newsletter information 910 is generated. The basic newsletter information 910 is retrieved from the database 135 as part of a basic profile stored for each newsletter 120A-C. The basic profile is created at the time the server 130 processed the master document 120 to create the unique newsletters 120A-C.

At 9-20, the newsletter statistics 920 is generated. To generate the newsletter statistics 920, the server 130 retrieves:
a count of clients who were sent the newsletter
a count of instances where an email containing the newsletter was not successfully delivered
a total count of all newsletters opened
a total count of all newsletters viewed
a total count of all URLs clicked
a total count of clients who accessed a webpage addressed by a URL in the newsletter
a total count of form submissions conducted from the webpage
a total count of newsletters forwarded by a client
a total count of clients who subscribed to the newsletter
a total count of clients who unsubscribed from the newsletter
a count of accesses to non-unique instances of the newsletter via social media platforms

The above retrieved information is displayed in the newsletter statistics 920. It is to be understood that other information may also be retrieved from the database 135.

Additionally, secondary information is derived from the above retrieved information through calculation by the server 130. Included in the derived secondary information are:
a click through rate calculated as a percentage of clients who clicked on a URL in the newsletter out of a total number of delivered newsletters
a percentage of successfully delivered newsletters out of a total count of sent newsletters
a percentage of unique newsletter opens out of total count of newsletter opens
a percentage of unique newsletter views out of a total count of newsletter views
a percentage of unique URL clicks out of a total count of URL clicks

The above secondary information is generated dynamically by the server 130 after the raw information is retrieved from the database. It is to be understood that other secondary information may also be generated from the retrieved information, as desired or set up in the system by the agent 100 or other administrator.

At 9-30, the newsletter recipient list 830 is generated. To generate the newsletter recipient list 830, the server 130 retrieves from the database 135 the list of all recipients of the newsletter, and subsequently retrieves from the database 135 relevant information about each recipient, including for example, the agent managing the recipient, and the total number of times each recipient opened, viewed, and forwarded the newsletter 120A-C.

At 9-40, the newsletter URL list 840 is generated. To generate the newsletter URL list 840, the server 130 retrieves from the database 135 a newsletter record and determines therefrom all URLs listed in the newsletter 120A-C. Further, from the newsletter record, the property and/or property listing 140 is determined. A count of how many times a particular URL was clicked on is determined as the count of times the property listing 140 was viewed.

It is to be understood that the operation 90 may be performed in a different order, and that the steps 9-10 to 9-40 need not be consecutive.

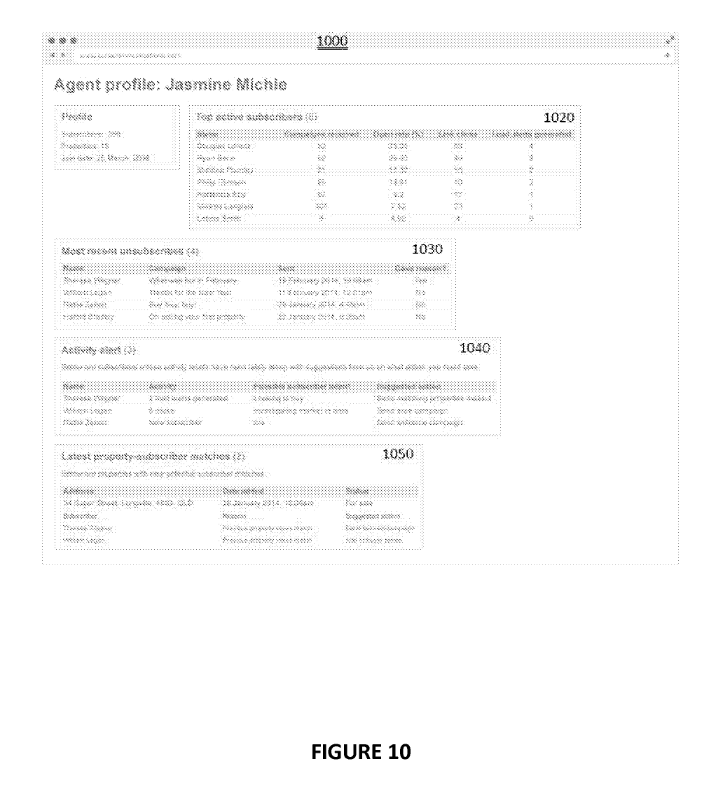

FIG. 10 illustrates an exemplary agent profile 1000. With reference to FIG. 10, the exemplary agent profile 1000 is described. The agent profile 1000 includes basic information 1010 of the agent, such as the number of subscribers an agent 100 has, and a number of properties currently listed by the agent 100. The basic information is obtained from the server 135, for example as a database query for all clients 110A-C who are listed as having the agent 100 as their agent, and a database query for all properties listed as being managed by the agent 100.

The agent profile 1000 further includes a subscriber activity picture 1020, illustrating activity statistics of an agent's clients 110A-C. The activity statistics, in one form, include a number of marketing materials 120A-C received by a client 110A-C, a marketing material open rate, a number of links clicked by a client, and the like.

An unsubscribers list 1030 is provided to identify to the agent 100 recent clients 110A-C who have unsubscribed from the mail out of marketing material 120A-C. The unsubscribers list 1010 provides the agent 100 with a list of clients 110A-C who may be targeted for personal contact, to better ascertain their needs.

An activity alert list 1040 is provided to identify to the agent 100 recent clients 110A-C whose recent activity levels have been pronounced. The activity alert list 1040 is generated, in one form, by a database query to the database 135 requesting for a list of clients 110A-C being managed by the agent 100, and filtering the list to include only clients 110A-C who have performed a predetermined number of predetermined activities over a predetermined period of time.

Additionally, a property-client match list 1050 may be included in the agent profile 1000. The property-client match list 1050 lists properties which the agent 100 has recently added, followed by a list of clients 110A-C whose client profile suggests that they may be interested in the recently added property. A suggested/recommended action is included in the property-client match list 1050 to recommend to the agent 100 what action to take for a particular client 110A-C.

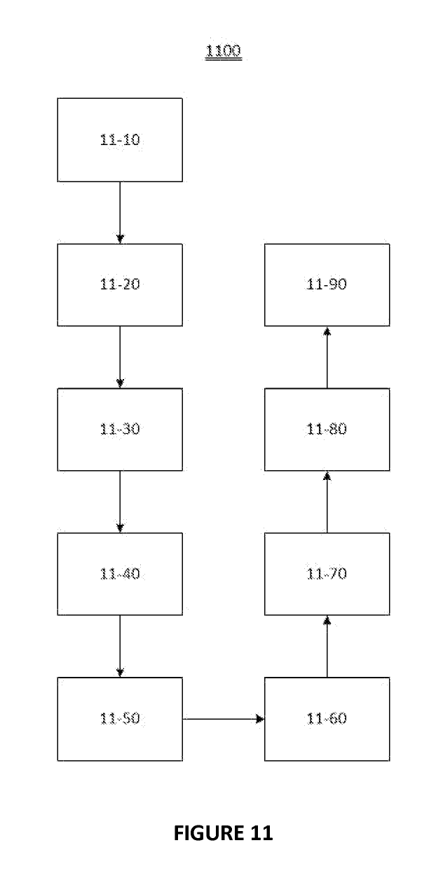

An operation 1100 for generating the agent profile 1000 is described with reference to the flow chart of FIG. 11. The operation 1100 commences, exemplarily, at 11-10 where the agent basic information 1010 is generated. The agent basic information 1010 is retrieved from the database 135 from an agent profile stored therein, created as part of an initial registration process of the agent 100 with the system 10.

At 11-20, the subscriber activity picture 1020 is generated. The subscriber activity picture 1010 is generated by retrieving from the database 135 all clients 110A-C who have listed as their agent the agent in question. From there, selected information about each client may be retrieved, such as a total count of newsletters 120A-C retrieved by each client, and a number of URLs clicked by each client 110A-C. Alternatively, or in addition thereto, a client profile generation operation 50, or a part thereof, may be conducted. From the retrieved information, secondary client activity information is generated, including a percentage open rate for each client 110A-C.

At 11-30, the unsubscribers list 1030 is generated. The unsubscribers list 1030 is generated by retrieving from the database a list of recently unsubscribed clients 110A-C.

At 11-40, the activity alert list 1040 is generated. The activity alert list 1040 is generated by analysing the activity of all clients 110A-C belonging to the agent in question, and identifying clients 110A-C whose activity is above predetermined thresholds. The predetermined thresholds, in one form, include the generation of one or more lead alerts (being a combination of client activities which result in an automatic alert sent to the agent 100), three or more URL clicks, or being a new subscriber. Other thresholds may also be configured.

At 11-50, a possible intent for each client 110A-C listed in the activity alert list 1040 is calculated. The possible intent for each client 110A-C is calculated by passing the client's activities through a plurality of heuristics. The plurality of heuristics include:
Looking to buy—The looking-to-buy heuristic analyses client activity to determine if a client is looking to purchase a property. The looking-to-buy heuristic analyses client activity for views of properties that are for sale, and accesses of ‘Buying Fact Sheets’ and similar informational material.
New subscriber—The new-subscriber heuristic determines if a client is a new subscriber. A new subscriber is defined as a client 110A-C who subscribed to the system 10 in the last week, fortnight, or other period of time. The new-subscriber heuristic compares the subscription dates of all subscribers with the period of time desired.
Investigating market area—The investigating-market-area heuristic determines if a client is investigating a particular suburb, location or area for properties. The investigating-market-area heuristic analyses client activity for views of multiple properties of varying characteristics, all in a certain area.

At 11-60, a suggested action for dealing with each client 110A-C is calculated. The suggested action for dealing with each client 110A-C is calculated based on the possible intent determined at 11-50.

At 11-70, the property-client match list 1050 is generated. To generate the property-client match list 1050, the characteristics (e.g. price, features, location) of all properties managed by the agent in question all retrieved from the database 135. Additionally, a client profile generation operation 50, or the part thereof to generate the property picture 430, is conducted for each client 110A-C managed by the agent 100. Each property managed by the agent 100 is then compared with the hypothetical ideal property in each client's property picture 40. In particular, a similarity in characteristics between the client's hypothetical ideal property and the characteristics of each property managed by the agent 100 is determined.

At 11-80, a list of properties and clients whose hypothetical ideal property have a predetermined threshold of similarity is generated. The predetermined threshold of similarity, in one form, is determined based on a number of shared characteristics between the hypothetical ideal property and each listed property. Additionally, a reason for why each property is matched with the clients in the property-client match list 1050 is provided. The reason is determined by, for example, listing the shared characteristics.

At 11-90, a suggested action for taking with each client in the property-client match list 1050 is determined. The suggested actions include, for example, the sending of a tailored campaign to the client, or addition of the client to an advertisement campaign series. The suggested actions, in one form, are generated based on a series of rules. An exemplary rule is, for example:

If (client has viewed >X properties in area Y) then
send area campaign regarding area Y
invite client to area workshop
invite client to participate in survey

It is to be understood that the operation 110 may be performed in a different order, and that the steps 11-10 to 11-90 need not all be consecutive.

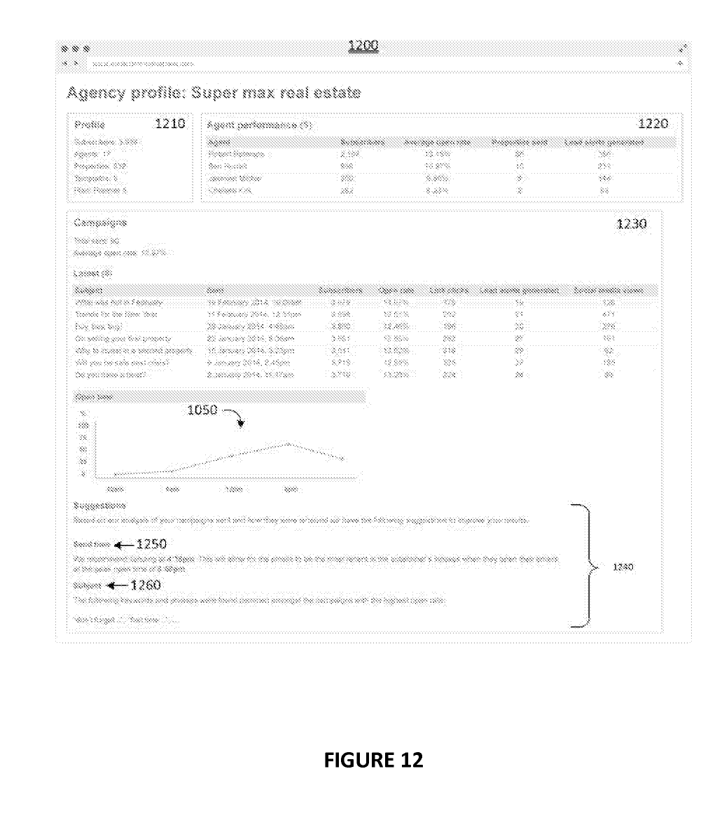

FIG. 12 illustrates an exemplary agency profile. The agency profile 1200 includes basic information 1210 of the agency, such as the total number of clients 110A-C managed by the agency, the number of agents in the agency, the number of properties being managed by the agency, and the like.

The agency profile 1200 further includes an agent performance picture 1220. The agent performance picture 1220 lists the number of clients 110A-C managed by each agent 100, an average open rate of marketing material by the clients 110A-C or each agent 100, number of properties sold by each agent 100, and the like.

Additionally, a campaign picture 1230 is provided in the agency profile 1200. The agency profile 1230 provides an overview of all marketing materials 120A-C sent out over a given period by agents 100 of the agency. The campaign picture 1230 lists, for example, each newsletter 120A-C, the date each newsletter 120A-C was sent, the number of clients 110A-C reached by each newsletter 120A-C, an open rate for each newsletter 120A-C, a total number of links clicked from each newsletter 120A-C, a total number of views from social media sources, and the like.

Still further, the agency profile 1200 includes a one or more recommendations and analysis 1240. Exemplary recommendations include a recommended send time 1250 for newsletters 120A-C to achieve an optimal open rate, and recommended keywords 1260 to include in the subject line of each newsletter 120A-C. The open rate graph 1270 provides a visual representation of the campaign history of newsletters 120A-C across the historic opens and provides the user with data on the best sending time 1250.

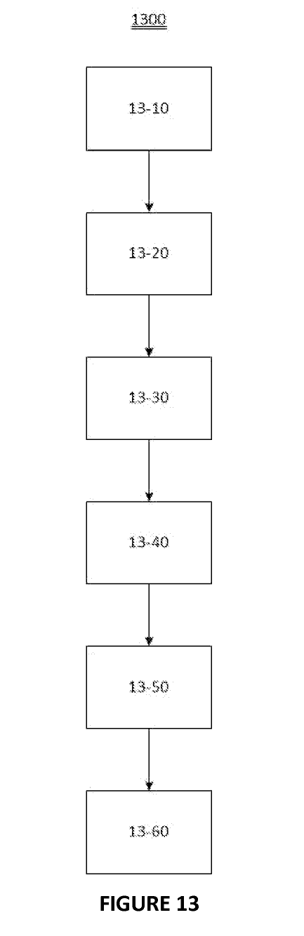

An operation 1300 for generating the agency profile 1200 is described with reference to the flow chart of FIG. 13. The operation 1300 commences, exemplarily, at 13-10 where basic agency information 1210 is generated. The basic agency information 1210 is generated by retrieving from the database 135 all clients being managed by agents 100 who are agents of the agency, and calculating a total thereof. Additionally, a count of all agents whose basic profile indicate they are an agent of the agency in question is calculated. Further, all listings 140 in the web portal 160 that are listed as being managed by an agent of the agency are determined, and a total thereof calculated.

At 13-20, the agent performance picture 1220 is generated. The agency performance picture 1220 is generated by retrieving from the database 135 a basic profile of all agents identified by the profile as being an agent of the agency in question. Additionally, for each agent, a query for all clients 110A-C who are managed by the agent is conducted to determine a total number of clients being managed by each agent. Other information as desired may also be retrieved from the database 135 to build the agent performance picture 1220. Secondary information such as an average open rate of newsletters 120A-C by the agent's clients overall may also be calculated from the retrieved information. Still further, an agent profile generation operation 1100, or part thereof, may be conducted for each agent 100.

At 13-30, the campaign picture 1230 is generated. To generate the campaign picture 1230, a count of all master documents 120 created after a predetermined date is calculated. An overall open rate for all campaigns is also calculated as an average of all average open rates for each newsletter 120A-C of each master document 120 sent in that period.

At 13-40, a list of recent newsletters 120A-C is listed. For each newsletter listed, a number of clients 110A-C addressed, an open rate, a number of links clicked, and the like are retrieved and calculated. In one form, a newsletter profile generating operation 90, or part thereof, is conducted for each recent newsletter.

At 13-50, the open time graph is generated. The open time graph graphically illustrates the open rates of newsletters at various hours of the day. The open time graph is generated by determining from client activity records stored in the database 135, each client who has opened one or more newsletters 120A-C, and the time that each client opened the one or more newsletters 120A-C. From this information, a graph, for example a histogram, is generated by the server 130 to indicate the number of newsletters 120A-C opened by clients 110A-C for each hour of the day. Additionally, or alternatively, the graph may illustrate a percentage open rate by hour.

At 13-60, the one or more recommendations and analysis 1240 is generated. In one form, the one or more recommendations and analysis 1240 include the recommended send time 1250 and the recommended keywords 1260. The recommended sent time 1250 is calculated as the time an email should be sent so as to be one of the most recent emails in a client's email inbox at the hour having the highest open rate. The recommended keywords 1260 is determined by a keyword heuristic that analyses the newsletters 120A-C with a high open rate, and looking for common keywords in the subject line of such newsletters. Other heuristics may also be executed to provide additional recommendations including:
Email length—Counting the number of customized words from campaigns that are viewed as being successful (e.g. have a high open rate and/or high click-through rate) and calculating the average from these campaigns, where customized words are deemed to be words manually added by the agent/agency, and words describing properties, and excluding words forming pro-forma paragraphs such as disclaimers and the like.
Email size: Averaging the email size from successful campaigns.
Content type: Counting the content type (e.g. number of news articles and number of properties) in successful campaigns, and averaging the count.

It is to be understood that the operation 1300 may be performed in a different order, and that the steps 13-10 to 13-60 need not all be consecutive.

The profiles generated by the profile generating operation 30 are generated dynamically and in near real time. The dynamic and near real time generation of the profiles is made possible by the continuous collection of client interaction data by the collection operation 20, and the use of networked systems including the server 130, agent electronic device 105, and network 150.

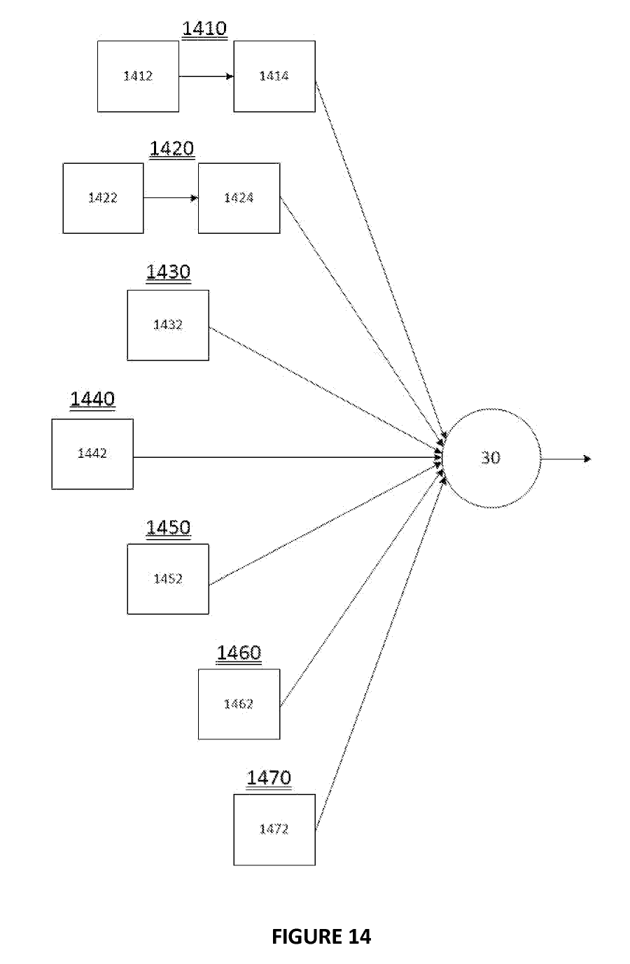

The profile generating operation 30 of the present invention may be triggered and/or otherwise initiated by a variety of means. FIG. 14 illustrates a plurality of triggers/initiators for the profile generating operation 30.

A first trigger/initiator 1410 for the profile generating operation 30 is a URL configured to commence a client profile generating operation 30. The client profile generation URL, in one form, is included in a lead alert 1414 sent to the agent 100. A lead alert 1414 is an automated alert sent to the agent 100 when one or more predetermined activities 1412 from a client 110A-C have been detected. An example of a predetermined activity that might trigger a lead alert 1414 is a detection of a client 110A-C viewing a particular property listing a predetermined number of times

A second trigger/initiator 1420 for the profile generating operation 30 is a URL configured to commence a property profile generating operation 30. The property profile generation URL, in one form, is included with each listing 1422 of a property managed by the agent 100, and in other forms is also included in a summary listing 1422 of all properties being managed by the agent 100. The property profile generation URL is clicked on 1424 by the agent 100 to commence the profile generating operation 30. The property profile generation URL instructs the profile generating operation 30 to generate a property profile, including a list of clients 110A-C who may be interested in the property.

A third trigger/initiator 1430 for the profile generating operation 30 is the listing 1432 of a new property on the portal 160. Upon the listing 1432 of a new property on the portal 160, the profile generating operation 30 is automatically commenced to generate a property profile 60.

A fourth trigger/initiator 1440 for the profile generating operation 30 is an explicit initiation 1442 of the operation 30 by the agent 100 to generate an agent profile 1000 for themselves. The generation of an agent profile 1000 allows the agent 100 to analyse their own performance and make informed adjustments to their marketing strategies based on the historical, statistical and other information provided by the agent profile 1000.

A fifth trigger/initiator 1450 for the profile generating operation 30 is an explicit initiation 1452 of the operation 30 by a managing agent to generate agent profiles 1000 for each agent 100 under the managing agent's supervision. The managing agent is thereby provided a performance review for each agent 100.

A sixth trigger/initiator 1460 of the profile generating operation 30 is an explicit initiation 1462 of the operation 30 by an agency manger to generate an agency profile 1200 for their agency. The generation of an agency profile 1200 allows the agency manager to analyse the performance of his/her own agency.

A seventh trigger/initiator 1470 of the profile generating operation 30 is an explicit initiation 1472 of the operation 30 by a regional manager in charge of a number of agency to generate a plurality of agency profiles 1200, one for each agency. The regional manager is thereby provided a performance review of each of the agencies under their care.

Other triggers/initiators of the profile generating operation 30 are configurable, and within the ability of an ordinarily skilled person having the benefit of present disclosure.

### ADVANTAGES

The advantages of the present invention include enabling agents to better target their marketing efforts. The gathering and analysis of client interaction data by the system of the present invention generates real-time analytics which provide insights, recommendations, and predictions that would otherwise not be possible were the system of the present invention not used.

Additionally, self-review and management-review of an agent's performance is facilitated, as is overall review of one or more agencies.

### VARIATIONS

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. A system to analyse client interaction history, the system comprising:
a server configured to receive and process a master document, and generate therefrom a plurality of unique newsletters, the server further configured to send a client one of the unique newsletters from the plurality of unique newsletters wherein the newsletter sent to the client is unique to them; and
a database storing therein records of all interaction activity with a unique newsletter by the corresponding client, wherein
the server is further configured to retrieve selected records from the database and calculate therefrom one or more statistics and recommendations for an agent.

2. A system to analyse client interaction history, the system comprising:
a server configured to receive and process a master document, and generate therefrom a plurality of unique newsletters, the server further configured to send to a client one of the unique newsletters from the plurality of unique newsletters wherein the newsletter sent to the client is unique to them;
a database storing therein records of all interaction activity with a unique newsletter by a corresponding client, wherein the server is further configured to retrieve selected records from the database and calculate therefrom one or more statistics and recommendations for an agent.
a first electronic device operated by the agent, the first electronic device operable to generate the master document so as to include one or more URL links to properties listed on an online web portal.

3. A system as claimed in claim 2, wherein each unique newsletter generated by the server contains therein URL links unique for each newsletter, each unique URL link corresponds to a URL link in the master document, whereby an interaction of the client with a unique URL link identifies the client and the client's interaction with the URL link to the database for recordal purposes.

4. A system as claimed in claim 2, wherein the server is configured to generate a variety of profiles for the agent, each profile comprising a different combination of statistics and recommendations generated using the records in the database.

5. A system as claimed in claim 2, wherein each unique newsletter generated by the server contains therein URL links unique for each newsletter, each unique URL link corresponds to a URL link in the master document, whereby an interaction of the client with a unique URL link identifies the client and the client's interaction with the URL link to the database for recordal purposes; wherein the server is configured to generate a client profile identifying the number of times the client opened a newsletter, the number of times the client clicked on the unique URL link in the newsletter, a hypothetical ideal property for the client, an estimated price range of the client, likely property locations desired by the client, and likely property types desired by the client.

6. A system as claimed in claim 2, wherein each unique newsletter generated by the server contains therein URL links unique for each newsletter, each unique URL link corresponds to a URL link in the master document, whereby an interaction of the client with a unique URL link identifies the client and the client's interaction with the URL link to the database for recordal purposes; wherein the server is configured to generate a client profile identifying the number of times the client opened a newsletter, the number of times the client clicked on the unique URL link in the newsletter, a hypothetical ideal property for the client, an estimated price range of the client, likely property locations desired by the client, and likely property types desired by the client; wherein the server is configured to retrieve from the database records of one or more properties previously viewed by the client, and calculate therefrom one or more of an average number of bedrooms of all properties, an average number of bathrooms of all properties, and an average number of parking spaces of all properties, whereby the hypothetical ideal property is identified as a property having the calculated average number of bedrooms, bathrooms, and parking spaces.

7. A system as claimed in claim 2, wherein each unique newsletter generated by the server contains therein URL links unique for each newsletter, each unique URL link corresponds to a URL link in the master document, whereby an interaction of the client with a unique URL link identifies the client and the client's interaction with the URL link to the database for recordal purposes; wherein the server is configured to generate a client profile identifying the number of times the client opened a newsletter, the number of times the client clicked on the unique URL link in the newsletter, a hypothetical ideal property for the client, an estimated price range of the client, likely property locations desired by the client, and likely property types desired by the client; wherein the server is configured to retrieve from the database records of all properties previously viewed by the client, and calculate therefrom an average price of all properties, whereby an estimated price range of the client is determined as the calculated price.

8. A system as claimed in claim 2, wherein each unique newsletter generated by the server contains therein URL links unique for each newsletter, each unique URL link corresponds to a URL link in the master document, whereby an interaction of the client with a unique URL link identifies the client and the client's interaction with the URL link to the database for recordal purposes; wherein the server is configured to generate a client profile identifying the number of times the client opened a newsletter, the number of times the client clicked on the unique URL link in the newsletter, a hypothetical ideal property for the client, an estimated price range of the client, likely property locations desired by the client, and likely property types desired by the client; wherein the server is configured to generate a graph illustrating the price ranges of all previously viewed properties as a percentage of all properties.

9. A system as claimed in claim 2, wherein each unique newsletter generated by the server contains therein URL links unique for each newsletter, each unique URL link corresponds to a URL link in the master document, whereby an interaction of the client with a unique URL link identifies the client and the client's interaction with the URL link to the database for recordal purposes; wherein the server is configured to generate a client profile identifying the number of times the client opened a newsletter, the number of times the client clicked on the unique URL link in the newsletter, a hypothetical ideal property for the client, an estimated price range of the client, likely property locations desired by the client, and likely property types desired by the client; wherein the server is configured to retrieve from the database records of all previous properties viewed by the client, determine therefrom the location of each property, and determine the most likely property locations desired by the client.

10. A system as claimed in claim 2, wherein each unique newsletter generated by the server contains therein URL links unique for each newsletter, each unique URL link corresponds to a URL link in the master document, whereby an interaction of the client with a unique URL link identifies the client and the client's interaction with the URL link to the database for recordal purposes; wherein the server is configured to generate a client profile identifying the number of times the client opened a newsletter, the number of times the client clicked on the unique URL link in the newsletter, a hypothetical ideal property for the client, an estimated price range of the client, likely property locations desired by the client, and likely property types desired by the client; wherein the server is configured to retrieve from the database records of all properties previously viewed by the client, determine therefrom the type of each property, and determine the most likely property type desired by the client.

11. A system as claimed in claim 2, wherein the server is configured to generate a variety of profiles for the agent, each profile comprising a different combination of statistics and recommendations generated using the records in the database; wherein the server is configured to generate a property profile identifying one or more of a client picture describing characteristics of a hypothetical client likely to be interested in a specific property, and a list of matching clients matching the hypothetical client.

12. A system as claimed in claim 2, wherein the server is configured to generate a variety of profiles for the agent, each profile comprising a different combination of statistics and recommendations generated using the records in the database; wherein the server is configured to generate a property profile identifying one or more of a client picture describing characteristics of a hypothetical client likely to be interested in a specific property, and a list of matching clients matching the hypothetical client; wherein the server is configured to retrieve from the database records of all client interactions indicative of a viewing of the specific property, determine therefrom characteristics of each client who viewed the specific property, and calculate therefrom one or more of an average client age, a statistical client gender, an average client salary, a statistical client marital status, and a list of common property locations, whereby the hypothetical client is identified as a person of the average age, of the statistically higher gender, earning the average client salary, of the statistically higher marital status, and who is looking for properties in locations listed in the list of common property locations.

13. A system as claimed in claim 2, wherein the server is configured to generate a variety of profiles for the agent, each profile comprising a different combination of statistics and recommendations generated using the records in the database; wherein the server is configured to generate a property profile identifying one or more of a client picture describing characteristics of a hypothetical client likely to be interested in a specific property, and a list of matching clients matching the hypothetical client wherein the server is configured to retrieve from the database a list of clients whose characteristics are within a predetermined matching threshold of those of the hypothetical client.

14. A system as claimed in claim 2, wherein the server is configured to generate a variety of profiles for the agent, each profile comprising a different combination of statistics and recommendations generated using the records in the database; wherein the server is configured to generate an agent profile identifying one or more clients of the agent determined by the server to be a match for one or more properties managed by the agent.

15. A system as claimed in claim 2, wherein the server is configured to retrieve from the database a list of clients whose recorded interaction activity exceed a predetermined threshold, to determine therefrom a possible intent of the client, and to generate a recommended action for the agent to take in relation to the client.

16. A system as claimed in claim 2, wherein the server is configured to determine from the database client interaction activity indicative of a predetermined number of unique URL links clicked by a client, analyse characteristics of properties represented by the clicked unique URL links, and determine that the client is investigating a market within an area if the properties are within a close geographic vicinity.

17. A system as claimed in claim 2, wherein the server is configured to determine from the database client interaction activity indicative of a predetermined number of unique URL links clicked by a client, analyse characteristics of properties represented by the clicked unique URL links, and determine that the client is investigating a market within an area if the properties are within a close geographic vicinity; wherein the server is configured to recommend to the agent the sending of informational material to the client about the area in response to determining that the client is investigating the marketing within the area.

18. A system as claimed in claim 2, wherein the server is configured to retrieve from the database one or more properties managed by the agent, retrieve from the database the interaction activity of all clients managed by the agent, and determined from the interaction activity if any clients are a match for the one or more properties.

19. A system as claimed in claim 2, wherein the server is configured to retrieve from the database client interaction activity on all newsletters sent in a predetermined period, and determine from the client interaction activity one or more of an optimal sending time for the newsletters, and an optimal subject description for the newsletters.

20. A system as claimed in claim 2, wherein the server is configured to retrieve from the database client interaction activity on all newsletters sent in a predetermined period, and determine from the client interaction activity one or more of an optimal sending time for the newsletters, and an optimal subject description for the newsletters; wherein the server is configured to retrieve from the database all interaction activity indicative of clients opening any of the newsletters sent in the predetermined period, the times of such occurrences, and determine therefrom the times during which a highest open rate occurred, whereby the optimal sending time for the newsletters is determined.

21. A system as claimed in claim 2, wherein the server is configured to retrieve from the database client interaction activity on all newsletters sent in a predetermined period, and determine from the client interaction activity one or more of an optimal sending time for the newsletters, and an optimal subject description for the newsletters; wherein the server is configured to retrieve from the database all interaction activity indicative of clients opening any of the newsletters sent in the predetermined period, the words present in a subject line of each of the newsletters, and the number of times each newsletter was opened, and determined therefrom the words present in the subject lines of the most opened newsletters, whereby the optimal subject description for the newsletters is determined.
